(19) United States
(12) Patent Application Publication
(10) Pub. No.: US 2013/0107385 A1
(43) Pub. Date: May 2, 2013

(54) Exterior Mirror Unit

(71) Applicant: Paulus Gerardus Maria van Stiphout, Woerden (NL)

(72) Inventor: Paulus Gerardus Maria van Stiphout, Woerden (NL)

(73) Assignee: MCi (Mirror Controls International) Netherlands B.V., Woerden (NL)

(21) Appl. No.: 13/574,757

(22) PCT Filed: Jan. 25, 2011
(86) PCT No.: PCT/NL11/50044

§ 371 Date: Oct. 26, 2012

(30) Foreign Application Priority Data
Jan. 25, 2010 (NL) 2004141

(51) Int. Cl. B60R 1/06

(52) U.S. Cl. CPC B60R 1/06
USPC 359/872

(57) ABSTRACT

Exterior mirror unit for a motor vehicle comprising a mirror base for attachment to the motor vehicle and a mirror support for attachment of a mirror element, wherein the minor support is merely manually adjustable relative to the minor base, further comprising a coupling element for coupling of the mirror support with the minor base, wherein the coupling element is designed to pull the minor support towards the mirror base.

The invention relates to an exterior mirror unit for a motor vehicle.

Exterior mirror units for motor vehicles are known. An exterior mirror unit usually comprises a mirror base for attachment to the motor vehicle, for example to a door of a car. Further, the exterior mirror unit usually comprises a mirror support for attachment of a reflecting element such as a mirror element. The mirror support may be provided with a mirror cap which can partly or wholly surround the mirror support and is usually arranged for esthetic and/or aerodynamic reasons and/or as a protection of the mirror support and components connected therewith.

The mirror support is usually adjustable relative to the mirror base. The mirror support is then pivotably adjustable substantially about an upward axis between an operational position, a park position and a fold-over position.

In the operational position or fold-out position the mirror support is substantially transverse to the mirror base and/or the motor vehicle. The mirror support is usually in the operational position during use of the motor vehicle, preferably during driving. In the park position or fold-in position the mirror support is substantially along the motor vehicle, with the reflecting element substantially facing the motor vehicle. The mirror support with a mirror cap, if any, thus hugs the motor vehicle more closely, so that there is less chance of damages. In the fold-over position the mirror support extends substantially forwardly along the motor vehicle, in a direction opposite to the fold-in position. In the fold-over position the reflecting element substantially faces away from the motor vehicle. For example, if the mirror support in the fold-in position points substantially towards the rear of the motor vehicle, then the mirror support in the fold-over position extends in a direction oriented substantially towards the front of the motor vehicle. For example, a mirror support may be in the fold-over position as a result of a collision with an object.

Adjustment of the mirror support relative to the mirror base may be done manually or automatically with the aid of an actuator. A majority of the exterior mirror units are exterior mirror units that are only hand-adjustable between a park position, an operational position and a fold-over position.

A disadvantage of exterior mirror units that can only be adjusted by hand is that relatively many parts are needed to connect the mirror base with the mirror support, so that the exterior mirror unit is relatively expensive. Also, it may be relatively complicated to connect the mirror support with the mirror base and detach it again, so that assembly of the exterior mirror unit can be relatively costly and replacement of, for example, a damaged mirror support can be relatively expensive.

An object of the invention is to provide a merely manually adjustable exterior mirror unit whereby at least one of the above-mentioned disadvantages can be counteracted.

To this end, the invention provides an exterior mirror unit for a motor vehicle comprising a mirror base for attachment to the motor vehicle and a mirror support for attachment of a mirror element, wherein the mirror support is merely manually adjustable relative to the mirror base, further comprising a coupling element for coupling of the mirror support with the mirror base, wherein the coupling element is designed to pull the mirror support towards the mirror base.

By providing a coupling element for coupling of the mirror support with the mirror base, the mirror support can be coupled with the mirror base in a simple manner. Furthermore, as a result of the coupling element being designed to pull the mirror support towards the mirror base so that the mirror support and the mirror base are coupled with each other under the influence of pull, the number of parts can be further reduced. Thus, for example, no collar and/or loose sleeve is needed, as in the case of a compression spring, to confine the spring. By the use of a coupling element which exerts a tensile force between the mirror support and the mirror base, just a single coupling part, viz., the coupling element itself, can substantially suffice.

The coupling element or pulling element can be, for example, an elastic element which exerts a tensile force, such as, for example, a tension spring. A tension spring is simple to connect with the mirror support on one side and the mirror base on the other. Also, the coupling element may be implemented as, possibly biased, pulling wires which are connected on one side to the mirror base and on the other to the mirror support to pull the mirror support towards the mirror base. Possibly, the coupling element could be implemented as a magnetic element which, under the influence of magnetic force, can couple with a metallic and/or magnetic part of the mirror base, thereby pulling the mirror support towards the mirror base.

By on one side fixedly connecting the end of the coupling element with the mirror base and on the other side movably connecting the opposite end of the coupling element with the mirror support, the mirror support can be manually adjusted relative to the mirror base between the operational position, the park position and the fold-over position while the tensile load between the mirror support and the mirror base is preserved. During adjustment, the movable end can move, for example, over an edge of the mirror support or over a, possibly metal, guide between the end of the elastic element and the edge of the mirror support. Possibly, both ends of the coupling element may be fixedly connected with the mirror support on one side and the mirror base on the other. Also, both ends of the coupling element may be movably connected with the mirror support on one side and the mirror base on the other. It may also be that one end of the coupling element is movably connected with the mirror base and the other end is fixedly connected with the mirror support.

Preferably, the mirror support is connected with the mirror base and the coupling element in a manner detachable as a whole. For example, the end of the coupling element connected with the mirror support can be detached from the mirror support relatively simply, while the other end of the coupling element, connected with the mirror base, can remain connected with the mirror base. Accordingly, the mirror support can be uncoupled from the coupling element and be detached. The coupling element remains connected with the mirror base. In a simple manner, the mirror support can thus be replaced, for example, in case of damage of the mirror support and/or of the mirror cap connected therewith, while the coupling element and the mirror base can be preserved.

Also, the coupling element may be so implemented that not an end but a different part of the coupling element is designed to be detached so that the mirror support can be uncoupled from the coupling element. For example, the coupling element may be provided with a clamped connection or a snap connection which can be released.

The detachable part of the coupling element is preferably well accessible, also after assembly of the mirror support. For example, the detachable part of the coupling element is accessible after the reflecting element has been detached from the mirror support. The reflecting element is usually simply detachably attached to the mirror support, for example, with the aid of a snap connection or clamped connection. Also, the detachable part of the coupling element may be accessible without the reflecting element and/or another element needing to be detached.

Advantageously, the mirror base is also couplable with a mirror support that is designed for receiving an actuator unit for automatically adjusting the mirror support relative to the mirror base. Thus, use can be made of just one mirror base for an exterior mirror unit in a manually adjustable version and an automatically adjustable version.

Still more advantageously, also the mirror support for the automatically adjustable version is substantially identical to the mirror support for the manually adjustable version of the exterior mirror unit. For example, the mirror support may be manufactured in the same mold, while for the manually adjustable mirror support an insert in the mold can be used, in order for the cavity, which in the case of the automatically adjustable mirror support will be occupied by the actuator unit, to be wholly or partly filled up with material, for example to create sufficient rigidity. By making use of the same mold, a saving of costs can thus be realized.

Further advantageous embodiments are represented in the subclaims.

The invention will be further elucidated on the basis of preferred embodiments which are represented in a drawing. In the drawing:

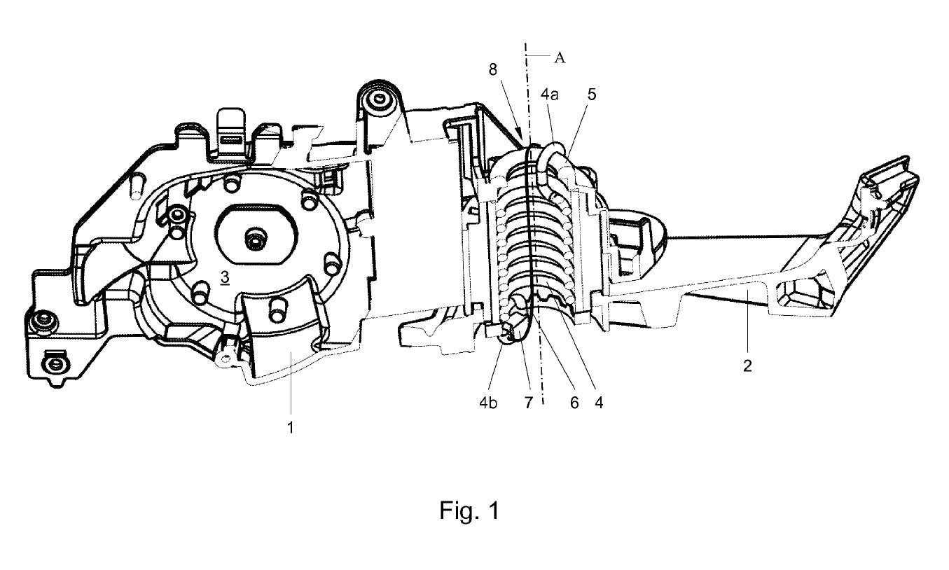

FIG. 1 shows a cross section of a mirror support with a mirror base according to the invention;

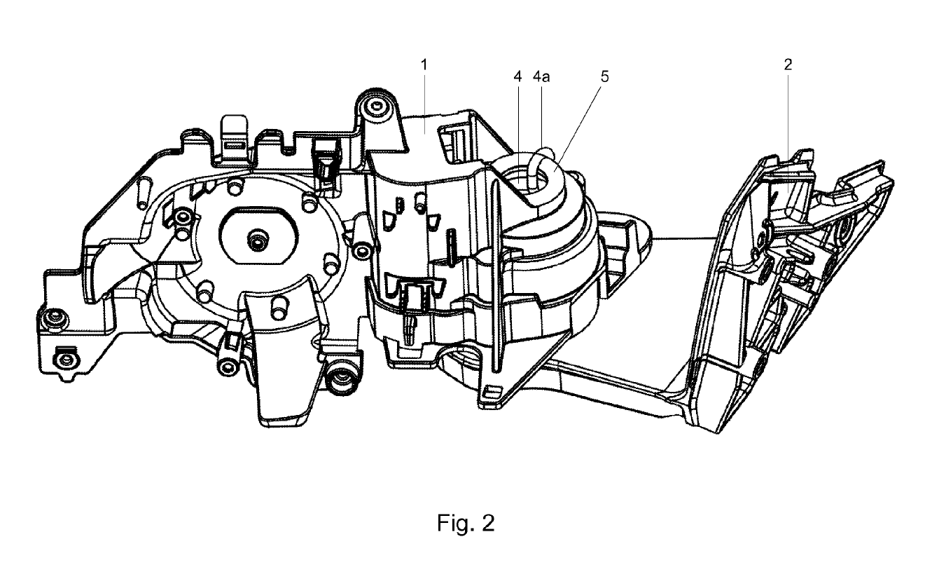

FIG. 2 shows a schematic perspective view of the mirror support with mirror base of FIG. 1.

In the drawing, like parts are designated with like reference numerals. The drawing is given by way of non-limiting exemplary embodiment.

FIG. 1 shows a mirror support 1 which is coupled with a mirror base 2. The mirror support 1 is designed to receive a reflecting element, for example, a mirror element. The mirror support 1 is here provided with a reception area 3 for a mirror element. The mirror element is not shown here. Around the mirror support 1 a mirror cap may be arranged, for example, to protect the mirror support 1 and any components and/or, for example, for esthetic and/or aerodynamic reasons. The mirror cap is not shown here.

The mirror base 2 is designed to be attached to a motor vehicle. The mirror support 1 is coupled with the mirror base 2 with the aid of a coupling element 4.

The mirror support 1 is only manually adjustable relative to the mirror base 2. The mirror support 1 is here adjustable relative to a substantially upwardly directed axis A between an operational position, a park position and a fold-over position. In the operational position the mirror support 1 is substantially transverse to the motor vehicle. In the park position the mirror support 1 is substantially along the motor vehicle, with the mirror element facing the motor vehicle. In the fold-over position the mirror support 1 also extends substantially along the motor vehicle, but forwardly now, with the mirror element facing away from the motor vehicle.

The coupling element 4 is here implemented as an elastic element, in particular as a tension spring. The tension spring pulls the mirror support 1 towards the mirror base 2 so that the mirror support 1 and the mirror base 2 are coupled.

One end 4b of the tension spring 4 is fixedly connected with the mirror base 2. In this exemplary embodiment the end 4b is formed as a ring-shaped element which can be assembled around a projection 7, here a pin, of the mirror base 2. Possibly, the projection 7 is provided with a lip behind which the end 4b can be placed so that a fixed connection between the end 4b of the tension spring 4 and the mirror base 2 can be effected.

The other end 4a of the tension spring 4 is movable relative to the mirror support 1. The end 4a is here designed as a hook-shaped element which can cooperate with an edge 5 of the mirror support 1. The end 4a is movable over the edge 5 of the mirror support 1. Optionally, between the end 4a and the edge 5, a for instance wear-resistant ring may be arranged or the edge 5 may be provided with a wear-resistant material. For example, the edge 5 may be provided with a groove in which the end 4a of the coupling element may be movably received. By taking the end 4a out of the groove, the coupling element can be detached from the mirror support.

Needless to say, the fixed and the movable end of the coupling element may also designed the other way around, or both ends may be fixedly connected or both ends may be movably connected. Also, the coupling element may be provided with a detachable connecting part, for example, a snap or a clamped connection, through which the detachable connection of the coupling element and the mirror support can be effected and/or released.

During pivoting of the mirror support 1 relative to the mirror base 2, in this exemplary embodiment the end 4b remains fixedly connected with the mirror base 2. During pivoting, the end 4a moves over the edge 5, so that also during adjustment the mirror support 1 is pulled towards the mirror base 2 by the tension spring 4.

Possibly, to prevent an unduly large displacement of the mirror support 1 relative to the mirror base 2 in the direction of the axis A, a stop element 6 may be provided. In this exemplary embodiment the stop element 6 is implemented as a wire element which on one side can be assembled around the projection 7 and on the other side can be folded around the edge 5. The length of the wire element 6 then defines the practical maximum axial displacement of the mirror support 1 relative to the mirror base 2. Other embodiments of the stop element 6 are also possible, for example, a stop.

In a simple manner the mirror support 1 can be detached from the tension spring 4, possibly the stop element 6, and the mirror base 2. By taking the end 4a off the edge 5, for example with the aid of tongs or using, for example, a pin or other means provided under the hook element 4a, by which the hook element 4a can be taken off the edge 5. Also the end of the stop element 6 on the side of the edge 5 may be simply moved away or detached so that the mirror support 1 can be detached from the tension spring 4, and possibly the stop element 6. The tension spring 4 is fixedly connected with the mirror base 2, so that the mirror support 1 can be easily detached from the tension spring 4 and the mirror base 2. The end 4a of the tension spring 4 is easily accessible after assembly of the mirror support 1 and possibly the mirror cap, for example by taking away the mirror element.

By making use of the tension spring 4, through a cylinder-shaped space enclosing the tension spring 4 and forming a hollow shaft 8, for example a cable harness can be guided. Other exemplary embodiments of the coupling element, for example, pulling wires or magnetic elements, may be so designed that the cable harness may also be guided through them or along them. The cable harness can comprise, for example, power cables and/or control cables and be guided from the motor vehicle through the hollow shaft 8 to the mirror support 1. The mirror support 1 can furthermore comprise electrically operable components, such as, for example, a lighting element and/or a mirror adjustment instrument which may be supplied and/or controlled by cables from the cable harness. Advantageously, the hollow shaft 8 is here around the pivoting axis A, so that the cable harness can be simply guided through. However, the cable harness may also be guided through the hollow shaft, for example formed by a sleeve, with the coupling element situated elsewhere on the construction between mirror support and mirror base to pull the mirror support towards the mirror base.

The mirror support 1 is preferably manufactured in the same mold as a mirror support which is designed to receive an actuator for automatic adjustment of the mirror support relative to the mirror base. Thus, just a single mirror base may be used for an exterior mirror unit that is manually adjustable and for an exterior mirror unit that is automatically adjustable. In the manufacture of a manually adjustable mirror support, an insert may be used in the mold in order that the cavity in which otherwise an actuator unit would be placed is wholly or partly filled up with material to obtain sufficient stiffness of the mirror support.

The invention is not limited to the exemplary embodiments represented here. The invention has been elucidated on the basis of a mirror support which is provided with a cavity in which possibly an actuator unit may be received. In this cavity, in the case of a manually adjustable mirror support, the coupling element may be arranged. However, the actuator unit and hence also the coupling element, may also be provided wholly or partly outside the mirror support. Many variants are possible and will be clear to those skilled in the art within the scope of the following claims.

1. An exterior mirror unit for a motor vehicle comprising a mirror base for attachment to the motor vehicle and a mirror support for attachment of a mirror element, wherein the mirror support is merely manually adjustable relative to the mirror base, further comprising a coupling element for coupling of the mirror support with the mirror base, wherein the coupling element is designed to pull the mirror support towards the mirror base.

2. The exterior mirror unit according to claim 1, wherein the coupling element is an elastic element.

3. The exterior mirror unit according to claim 2, wherein the elastic element is a tension spring.

4. The exterior mirror unit according to claim 1, wherein a part of the coupling element is detachably connected with the mirror support.

5. The exterior mirror unit according to claim 4, wherein the detachable part is an end of the coupling element.

6. The exterior mirror unit according to claim 1, wherein the mirror support is coupled with the mirror base and the coupling element in a manner detachable as a whole.

7. The exterior mirror unit according claim 1, wherein an end of the coupling element is fixedly connected with at least one of the mirror base and mirror support and an opposite end of the coupling element is movable relative to the other of the at least one of the mirror support and mirror base.

8. The exterior mirror unit according to claim 1, wherein the mirror base is couplable with a mirror support which is designed to receive an actuator unit for automatically adjusting the mirror support relative to the mirror base.
